(19) United States
(12) Patent Application Publication
(10) Pub. No.: US 2013/0221657 A1
(43) Pub. Date: Aug. 29, 2013

(54) VENT PIPE CONNECTOR

(71) Applicant: William F. Liebau, Plymouth, MI (US)

(72) Inventor: William F. Liebau, Plymouth, MI (US)

(21) Appl. No.: 13/778,022

(22) Filed: Feb. 26, 2013

Related U.S. Application Data
(60) Provisional application No. 61/603,768, filed on Feb. 27, 2012.

(51) Int. Cl. F16L 25/00

(52) U.S. Cl. CPC F16L 25/00
USPC 285/53

(57) ABSTRACT

A vent pipe connector that includes a planar base having a front surface, a back surface, a first end and a second end, an attachment strap attached to the first end of the planar base, the attachment strap having a first end and a second end and a hook and loop fastener attached to the second end of the planar base and the second end of the attachment strap. The vent pipe connector also includes an insulation layer attached to the back surface of the planar base, the insulation layer provides an insulating quality to the pipe vent connector and a reflective layer attached to the insulation layer, the reflective layer provides a heat and energy reflective quality to the pipe vent connector.

This application claims priority to U.S. Provisional Application 61/603,768 filed on Feb. 27, 2012, the entire disclosure of which is incorporated by reference.

### FIELD OF THE INVENTION

The present invention generally relates to a pipe connector. More specifically, the invention is a vent pipe connector such as a dryer vent pipe connector.

### BACKGROUND OF THE INVENTION

Vent pipes such as dryer vent pipes are often required to be connected. Unfortunately, many times these connections are poor and the dryer vent pipes are often simply taped together. The present invention provides an easier way to connect and seal dryer vent pipes or other suitable vent pipes, without tape and without creating leaks.

### SUMMARY OF THE INVENTION

The present invention generally relates to a connector. More specifically, the invention is a vent pipe connector such as a dryer vent pipe connector.

The vent pipe connector includes a planar base having a front surface, a back surface, a first end and a second end, an attachment strap attached to the first end of the planar base, the attachment strap having a first end and a second end and a hook and loop fastener attached to the second end of the planar base and the second end of the attachment strap. The vent pipe connector also includes an insulation layer attached to the back surface of the planar base, the insulation layer provides an insulating quality to the pipe vent connector and a reflective layer attached to the insulation layer, the reflective layer provides a heat and energy reflective quality to the pipe vent connector.

It is an object of the invention to provide a vent pipe connector that is an easier way to connect and seal dryer vent pipes or other suitable vent pipes, without tape and without creating leaks.

It is an object of the invention to provide a vent pipe connector that provides a reusable, stretchable, heat-resistant seal with insulated triple-layer protection.

It is an object of the invention to provide a vent pipe connector that secures vent pipes using integrated tie-straps or a hook and loop fastener.

### BRIEF DESCRIPTION OF THE DRAWINGS

The present invention will be described by way of exemplary embodiments, but not limitations, illustrated in the accompanying drawings in which like references denote similar elements, and in which:

FIG. 1 illustrates a side perspective view of a pipe vent connector, in accordance with one embodiment of the present invention.

FIG. 2 illustrates a top perspective view of a pipe vent connector, in accordance with one embodiment of the present invention.

FIG. 3 illustrates a top exploded perspective view of a pipe vent connector, in accordance with one embodiment of the present invention.

### DETAILED DESCRIPTION OF ILLUSTRATIVE EMBODIMENTS

Various aspects of the illustrative embodiments will be described using terms commonly employed by those skilled in the art to convey the substance of their work to others skilled in the art. However, it will be apparent to those skilled in the art that the present invention may be practiced with only some of the described aspects. For purposes of explanation, specific numbers, materials and configurations are set forth in order to provide a thorough understanding of the illustrative embodiments. However, it will be apparent to one skilled in the art that the present invention may be practiced without the specific details. In other instances, well-known features are omitted or simplified in order not to obscure the illustrative embodiments.

Various operations will be described as multiple discrete operations, in turn, in a manner that is most helpful in understanding the present invention, however, the order of description should not be construed as to imply that these operations are necessarily order dependent. In particular, these operations need not be performed in the order of presentation.

The phrase “in one embodiment” is used repeatedly. The phrase generally does not refer to the same embodiment, however, it may. The terms “comprising”, “having” and “including” are synonymous, unless the context dictates otherwise.

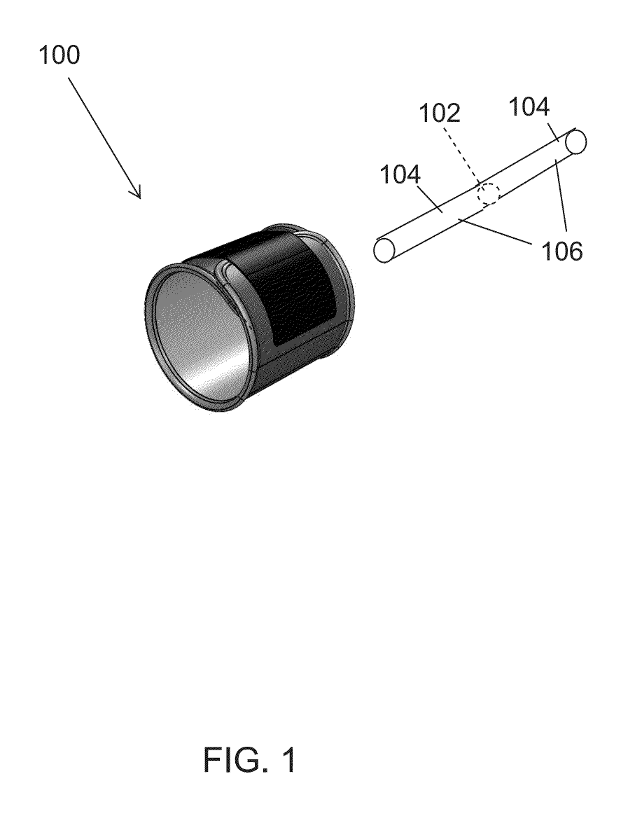

FIG. 1 illustrates a side perspective view of a pipe vent connector 100, in accordance with one embodiment of the present invention.

The pipe vent connector 100 illustrated in FIG. 1 is in a secured position. The pipe vent connector 100 is typically secured around a seam 102 between two vent pipes 104 such as two dryer vent pipes 106. The pipe vent connector 100 can also be secured around a seam 102 between two vent pipes 104 such as two heat pipes, two air conditioning or cooling pipes or other suitable pipes or object. Specifically, the pipe vent connector 100 prevents lint, heat or energy, other material or fumes from escaping the seam 102 or the two vent pipes 104.

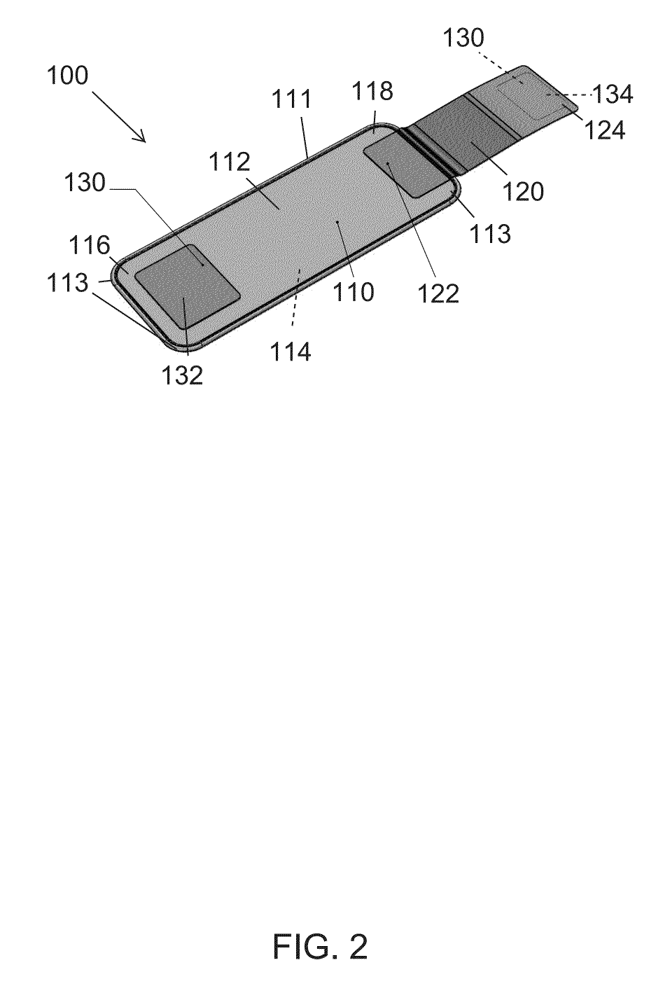

FIG. 2 illustrates a top perspective view of a pipe vent connector 100, in accordance with one embodiment of the present invention.

The pipe vent connector 100 includes a planar base 110, an attachment strap 120 and a hook and loop fastener 130. The planar base 110 has a front surface 112, a back surface 114, a first end 116 and a second end 118. The planar base 110 is made of fabric such as therma flec fabric or other suitable material. The planar base 110 can have a generally rectangular shape 111 with rounded corners 113. The attachment strap 120 is attached to the first end 116 of the planar base 110. The attachment strap 120 has a first end 122 and a second end 124. Specifically, the first end 122 of the attachment strap 120 is attached to the first end 116 of the planar base 110. The first end 122 of the attachment strap 120 can be sewn to the front surface 112 and the first end 116 of the planar base 110 or attached by other suitable attachment. The first end 116 and the second end 124 of the pipe vent connector 100 are cut at overlapping angles to achieve a strong seal. The attachment strap 120 can be made of nylon, nylon webbing, an elastic material or any other suitable material. The hook and loop fastener 130 is attached to the second end 118 of the planar base 110 and the second end 124 of the attachment strap 120. The hook and loop fastener 130 has a hook portion 132 and a loop portion 134. The hook portion 132 or the loop portion 134 can be attached to the first end 122 or the second end 124 of the attachment strap 120. The attachment strap 120 is releasably secured to a seam 102 between two vent pipes 104 such as two dryer vent pipes 106 or other suitable pipe or object when the hook portion 132 and the loop portion 134 are releasably coupled by depressing the hook portion 132 and the loop portion 134 together thereby releasably coupling the attachment strap 120. The term releasably coupling is defined as releasing the coupling between the hook portion 132 and the loop portion 134 as desired. The attached pipe vent connector 100 prevents lint, heat or other material or energy from escaping the seam 102 or the two vent pipes 104.

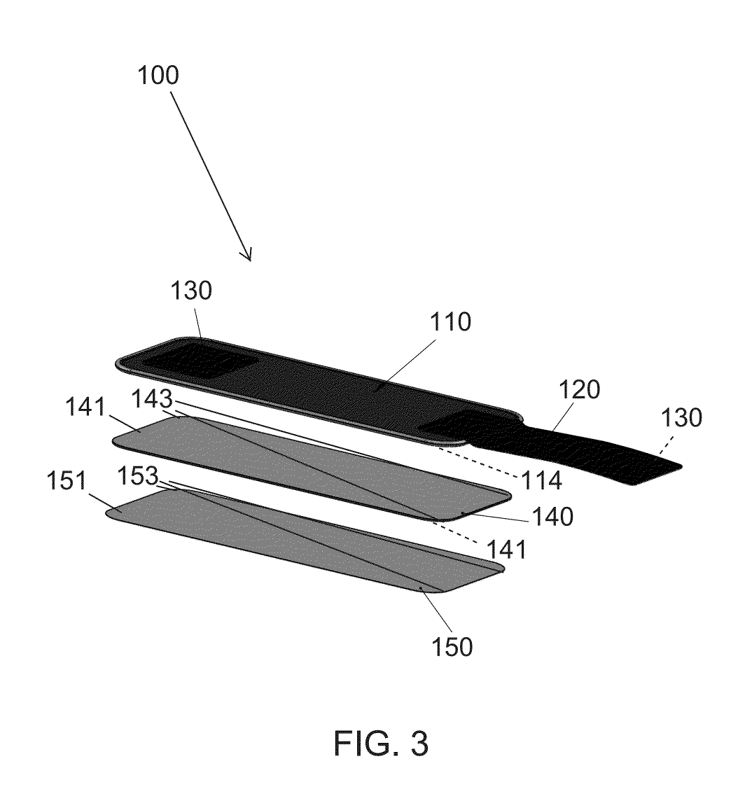

FIG. 3 illustrates a top exploded perspective view of a pipe vent connector 100, in accordance with one embodiment of the present invention.

The pipe vent connector 100 includes the planar base 110, the attachment strap 120, the hook and loop fastener 130, an insulation layer 140 and a reflective layer 150. The insulation layer 140 is attached to the back surface 114 of the planar base 110 and has a generally rectangular shape 141 with rounded corners 143 and is attached to the entire surface area of the back surface 114 of the planar base 110. The insulation layer 140 can be glued, sewn or attached by other suitable attachment. The insulation layer 140 provides an insulating quality to the pipe vent connector 100. The insulation layer 140 is made of material containing thin fibers of glass formed into a woven layer or FIBERGLASS™ or any other suitable material. The reflective layer 150 is attached to the insulation layer 140 and can be glued, sewn or attached by other suitable attachment. The reflective layer 150 has a generally rectangular shape 151 with rounded corners 153 and is attached to the entire surface area of the insulation layer 140. The reflective layer 150 provides a heat and energy reflective quality to the pipe vent connector 100. The reflective layer 150 is made of a polyester film or a plastic sheet from the resin polyethylene terephthalate or MYLAR®, fabric, rubber or any other suitable material.

The pipe vent connector serves as a quick, easy way to create a snug, secure fit at vent-pipe joints, even in tight spaces. The pipe vent connector helps ensure that lint doesn't get expelled out, which means less time spent cleaning-up a laundry room or other surrounding areas. The pipe vent connector helps keep potentially harmful exhaust fumes from escaping as well. The pipe vent connector is easy to remove for cleaning, easy to reattach with no messy duct tape needed, which can also leave sticky residue on attached pipes. The pipe vent connector also won't compromise or alter the structure of the attached vent pipes.

The pipe vent connector has a sturdy construction that includes a triple-layered insulated tube, a reflective inner layer, a FIBERGLASS™ mid-layer and a fabric or a rubber outer layer. The ends of the pipe vent connector are cut at overlapping angles to achieve a strong seal. The integrated adjustable tie-straps or a hook and loop or VELCRO® fastener attached to the outer layer of the pipe vent connector keeps the pipe connections tight without damaging any attached pipes. The pipe vent connector can be utilized in a wide variety of applications. Although the pipe vent connector is primarily for dryers (4″ diameter pipes for example), it could also be used over heating ducts, air-conditioning units and more. Different lengths can be made available to accommodate usage in different scenarios.

The pipe vent connector keeps dryer-vent pipe connections sealed together without needing tape and without creating leaks at a connection joint. This helps ensure lint passing through a vent pipe stays in the vent pipe until it reaches the exterior dryer vent resulting in no released lint. The pipe vent connector helps keep laundry rooms and other surrounding spaces cleaner. The pipe vent connector also helps keep any potentially harmful exhaust fumes from escaping into a surrounding area. The sturdy, durable insulated pipe vent connector is reusable, stretchable and heat-resistant. The pipe vent connector includes three layers: a reflective inner layer, a fiberglass mid-layer and a fabric or a rubber outer layer. The ends of the pipe vent connector are cut at overlapping angles in order to achieve a well-suited seal with adjustable tie-straps, or a VELCRO® fastener, on the outer layer to help ensure the connection remains safely snug and secure. Different lengths and sizes could be made available, allowing the pipe vent connector to be used not only for dryer connection joints, but for connections along heating ducts and air-conditioning units as well.

The pipe vent connector is well-suited to properly and securely connect dryer vent pipes together, in order to run lint away from the dryer to another part of the house (i.e. the exterior of the house). Utilizing the pipe vent connector is very easy. After connecting two vent pipes together, the pipe vent connector is wrapped around a joint to provide a secure hold between the two pipes. Adjustable tie-straps or a hook and loop or VELCRO® fastener are integrated as part of the pipe vent connector to ensure a secure hold at the joint. By utilizing the pipe vent connector, lint can be safely and effectively transferred to the exterior dryer vent and not dispersed all over a laundry room or other surrounding area.

While the present invention has been related in terms of the foregoing embodiments, those skilled in the art will recognize that the invention is not limited to the embodiments described. The present invention can be practiced with modification and alteration within the spirit and scope of the appended claims. Thus, the description is to be regarded as illustrative instead of restrictive on the present invention.

What is claimed is:

1. A vent pipe connector, comprising:
a planar base having a front surface, a back surface, a first end and a second end;
an attachment strap attached to the first end of the planar base, the attachment strap having a first end and a second end;
a hook and loop fastener attached to the second end of the planar base and the second end of the attachment strap;
an insulation layer attached to the back surface of the planar base, the insulation layer provides an insulating quality to the pipe vent connector; and
a reflective layer attached to the insulation layer, the reflective layer provides a heat and energy reflective quality to the pipe vent connector.

2. The vent pipe connector according to claim 1, wherein the planar base has a generally rectangular shape with a plurality of rounded corners.

3. The vent pipe connector according to claim 1, wherein the planar base is made of fabric.

4. The vent pipe connector according to claim 1, wherein the first end of the attachment strap is attached to the first end of the planar base.

5. The vent pipe connector according to claim 1, wherein the first end of the attachment strap is sewn to the front surface and the first end of the planar base.

6. The vent pipe connector according to claim 1, wherein the first end and the second end of the pipe vent connector are cut at overlapping angles to achieve a strong seal.

7. The vent pipe connector according to claim 1, wherein the attachment strap is made of material selected from the group consisting of nylon, nylon webbing or an elastic material.

8. The vent pipe connector according to claim 1, wherein the insulation layer is made of material containing thin fibers of glass formed into a woven layer.

9. The vent pipe connector according to claim 1, wherein the reflective layer is made of material selected from the group consisting of a polyester film or a plastic sheet from a resin polyethylene terephthalate, fabric or rubber.

10. The vent pipe connector according to claim 1, wherein the pipe vent connector is secured around a seam between two vent pipes to prevent lint, heat, energy or fumes from escaping the seam or the two vent pipes.

11. A dryer vent pipe connector, comprising:
a generally rectangular shape planar base having a front surface, a back surface, a first end and a second end;
a generally rectangular shape attachment strap attached to the first end of the planar base, the attachment strap having a first end and a second end;
a hook and loop fastener attached to the second end of the planar base and the second end of the attachment strap;
a generally rectangular shape insulation layer attached to the back surface of the planar base, the insulation layer provides an insulating quality to the pipe vent connector; and
a generally rectangular shape reflective layer attached to the insulation layer, the reflective layer provides a heat and energy reflective quality to the pipe vent connector.

12. The dryer vent pipe connector according to claim 11, wherein the planar base has a generally rectangular shape with a plurality of rounded corners.

13. The dryer vent pipe connector according to claim 11, wherein the planar base is made of therma flec fabric.

14. The dryer vent pipe connector according to claim 11, wherein the first end of the attachment strap is attached to the first end of the planar base.

15. The dryer vent pipe connector according to claim 11, wherein the first end of the attachment strap is sewn to the front surface and the first end of the planar base.

16. The dryer vent pipe connector according to claim 11, wherein the first end and the second end of the pipe vent connector are cut at overlapping angles to achieve a strong seal.

17. The dryer vent pipe connector according to claim 11, wherein the attachment strap is made of material selected from the group consisting of nylon, nylon webbing or an elastic material.

18. The dryer vent pipe connector according to claim 11, wherein the insulation layer is made of material containing thin fibers of glass formed into a woven layer.

19. The dryer vent pipe connector according to claim 11, wherein the reflective layer is made of material selected from the group consisting of a polyester film or a plastic sheet from a resin polyethylene terephthalate, fabric or rubber.

20. The dryer vent pipe connector according to claim 11, wherein the dryer pipe vent connector is secured around a seam between two vent pipes to prevent lint, heat, energy or fumes from escaping the seam or the two vent pipes.
